(19) United States
(12) Patent Application Publication
(10) Pub. No.: US 2017/0297500 A1
(43) Pub. Date: Oct. 19, 2017

(54) Portable Golf Bag Carrying and Transporting Device

(71) Applicants: Guadalupe Arellanes, Tijeras, NM (US); James Arellanes, Tijeras, NM (US)

(72) Inventors: Guadalupe Arellanes, Tijeras, NM (US); James Arellanes, Tijeras, NM (US)

(21) Appl. No.: 15/099,024

(22) Filed: Apr. 14, 2016

(51) Int. Cl. B60R 9/08; A63B 55/00; B65D 21/08; B65D 81/02

(52) U.S. Cl. CPC B60R 9/08; B65D 81/02; A63B 55/00; B65D 21/086

(57) ABSTRACT

The golf bag carrying and transporting device of the present invention comprises at least one immobilizing flap that allows it to be secured inside a vehicle without shifting position as the vehicle moves, and it can carry and transport a single or multiple golf back and other accessorites. The immobilizing flap is securely affixed to one side of the container, and is protrudes through the base of the tailgate, trunk or door of the vehicle, stabilizing the golf bag carrier in the golf bag area of the vehicle.

### Cross-Reference to Related Applications

None

### Statement Regarding Federally Sponsored Research and Development

Not applicable

### Names of the Parties to a Joint Research Agreement

Not applicable

### Incorporation-by-Reference ff Material Submitted on a Compact Disc

Not applicable

### BACKGROUND OF THE INVENTION

### Field of the Invention

The present invention relates generally to golf bag carrying and transporting containers and more specifically to an easily assembled and stored golf bag golf bag carrying and transporting container comprising attaching and immobilizing means capable of protecting the integrity of the golf bag and clubs, and keeping the container and the golf bag from shifting during transport in a vehicle.

### Description of the Related Art Including Information Disclosed Under 37 CFR 1.97 and 37 CFR 1.98

The following description of the art related to the present invention refers to a number of publications and references. Discussion of such publications herein is given to provide a more complete background of the principles related to the present invention and is not to be construed as an admission that such publications are necessarily prior art for patentability determination purposes.

Most golf bag carrying devices are geared for two basic uses: (1) carrying golf club bags in a car; and (2) carrying and protecting golf club bags during transportation, most notably, air travel. Further, most golf bag carrying and transporting devices of the prior art used to carry golf club bags in cars required some kind of fitting or invasive modification to the car. The need for devices that allow golfers to transport their golf club bags on a car arose almost immediately after cars became a popular mode of transportation. The USPTO granted Pat. No. 1,626,771 to Frisk in 1925 for a golf bag carrier capable to being mounted on a car. Like most subsequent patents granted in the field, the device disclosed and claimed in the Frisk patent required a series of securing attachements to the car itself.

The same requirement has been present in most of the golf bag carrying and/or transporting devices of the prior art. For example, St. Clair (U.S. Pat. No. 4,061,257) disclosed and claimed a car rack for golf carts including attachment elements to the outside of a car's trunk. Further improvements of the same basic idea have taken all kinds of shapes and have used different materials, which some of them being capable of being attached to a hitch attached to the car. (see U.S. Pat. Nos. 5,400,933 to Murray; 6,039,227 to Stark; 6,427,887 to Chain; 6,401,998 to Puluso; 6,478,203 to Burns; and 6,554,171 to Ewin).

Another issue either unaddressed or unresolved by the prior art patents is the portability, storability and ease of handling of the golf bag carrying devices. Most of them are made out of metal, so they are heavy. Also, most of them require some kind of hard-surface housing for the golf club bag and its contents to stay in place. Many people try to just place their golf club bag in their car's or sport utility vehicle's (“SUV”) truck or on a pick up truck. When attempting to do so, one often finds that the contents of the golf club bag end up spilling out and sometimes the clubs end up damaged. That is usually the result of the golf bag sliding around when the vehicle starts, stops or turns. Specifically, in the case of pick up trucks, the bed of the pick-up truck is typically slanted towards the cab of the truck when there is a small or light load making objects even more prone to shifting forward during stops. Large items like golf bags can be tied or strapped down to keep them from shifting. However, that usually requires additional work and some sort of securing device attached to the truck bed. Further, many pick-up trucks do not have any adequate features that come standard with the vehicle to secure the golf bag.

The main objective of the invention embodied in the present application is to provide a light, durable and easily assembled and stored golf bag carrying and transporting container capable of being secured or engaged to different parts of a vehicle to safely transport golf bags from any location to another. An ideal portable golf bag carrier would have to be lightweight and capable of being easily folded and stored while not in use.

### BRIEF SUMMARY OF THE INVENTION

Objects, advantages and novel features, and further scope of applicability of the present invention will be set forth in part in the detailed description to follow, taken in conjunction with the accompanying drawings. The objects, advantages and novel features, and further scope of applicability of the present invention will become apparent to those skilled in the art upon examination of the following, or may be learned by practice of the invention. The objects and advantages of the invention may be realized and attained by means of the instrumentalities and combinations particularly pointed out in the appended claims.

The present application discloses and claims a lightweight, portable and easily storable golf bag carrying and transporting device comprising one or elements capable of immobilizing the golf bag while being carried inside the trunk of a car or on a pick up truck golf bag bed.

The golf bag carrying and transporting device of the present invention comprises a unitary device that can be fast and easily assembled for use to carry one or multiple golf bags. It can also be disasembled for storage as a thin, light and easy to storage object.

The golf bag carrying and transporting device of the present application is easily placed and removed form a car or SUV trunk, or from a pick up truck's bed. The removable golf bag carrier disclosed and claimed herein is temporarily secured to a vehicle using the pressure of the vehicle's hatchback door, trunk door or truck tailgate through a restraining system, comprising an immobilizing flap, thus preventing movement of the golf bag carrier and therefore potential damage to its contents. The restraining system, comprising an immobilizing flap, keeps the carrying device and the golf bag from shifting during transport in a vehicle by restraining the items when the vehicle stops, accelerates, or turns. The portable golf bag carrier is ideal for the golf bag area of an SUV or hatchback, vehicle trunk or truck bed. The golf bag carried is secured by, for example, placing the restraining system comprising an immobilizing flap in the door jam of the vehicle's hatchback door or trunk, or the space between the end of its truck bed and open tailgate. The door, trunk or tailgate is then closed on the immobilizing flap, which secures the carrier due to the pressure of the door placed on it.

The preferred embodiment of the invention is collapsible into a flattened and folded form that allows for simple storage when not in use. The device of the present application does not require any modification or alteration to the transport vehicle, or having to place any device or invasive contraption on any part of the vehicle.

The object of the invention embodied in the present application is to provide a reusable, durable and portable golf bag carrying and transporting container that can be easity assembled and used without tools or fastening hardware, and without having to set or install any brackets, or having to make any other modification or alteration (e.g. dilling holes) to the vehicle or truck bed.

Another object of the present invention is to provide a portable golf bag carrying and transporting system that can be easily assembled and does not require the use of any nets or hooks in order to be used for its intended purposes of its immobilizing, holding and carrying a golf bag(s).

Another object of the present invention is to provide a portable golf bag carrying and transporting device that can be partially assembled and secured so it can contain two golf bags, or it can be completely assembled to contain a single golf bag.

Another object of the present invention is to provide a portable golf bag carrying and transporting system comprising an immobilizing flaps that can be assembled to securely hold and immobilize a single golf bag or several golf bags in the back of a pick-up truck, vehicle or SUV, and keep it from shifting during vehicle operations.

Another object of the present invention is to provide a portable golf bag carrying and transporting device comprising an immobilizing flaps that is easy and inexpensive to manufacture, and is simple to operate.

Another object of the present invention is to provide a portable golf bag carrying and transporting assembly comprising one or more immobilizing flaps that can be easily folded flat and stowed away when not in use.

Another object of the present invention is to provide a portable golf bag carrying and transporting device comprising one or more an immobilizing flaps that is fashionable or appealing to the eye.

### BRIEF DESCRIPTION OF THE SEVERAL VIEW OF THE DRAWINGS

The accompanying drawings, which are incorporated into and form a part of the specification, illustrate an embodiment of the present invention and, together with the description, serve to explain the principles of the invention. The drawings are only for the purpose of illustrating a preferred embodiment of the invention and are not to be construed as limiting the invention.

FIG. 1: is a top perspective view of the preferred embodiment of the invention partly open, showing the receiving and engaging means and the immobilizing flap fully extended. In that configuration, the container of the present invention is capable of receiving multiple golf bags.

FIG. 2: is a front perspective view of the preferred embodiment of the invention.

FIG. 3: is a rear perspective view of the preferred embodiment of the invention.

FIG. 4: is a bottom perspective view of the preferred embodiment of the invention.

FIG. 5: is a front perspective view of the preferred embodiment of the invention closed to form front open cuboid. In that configuration, the container of the present invention is capable of receiving a single golf bag.

### DETAILED DESCRIPTION OF THE INVENTION

The golf bag carrying and transporting device of the present invention is a container that comprises a single restraining device in the form of an immobilizing flap that allows the assembled container to be secured in a vehicle's trunk or pick up truck's bed without shifting position as the vehicle moves. The golf bag container of the present invention is made of sturdy fabric, leather or synthetic materials, and can be folded resulting in a lightweight, thin and flat configuration that can be stored in a small space.

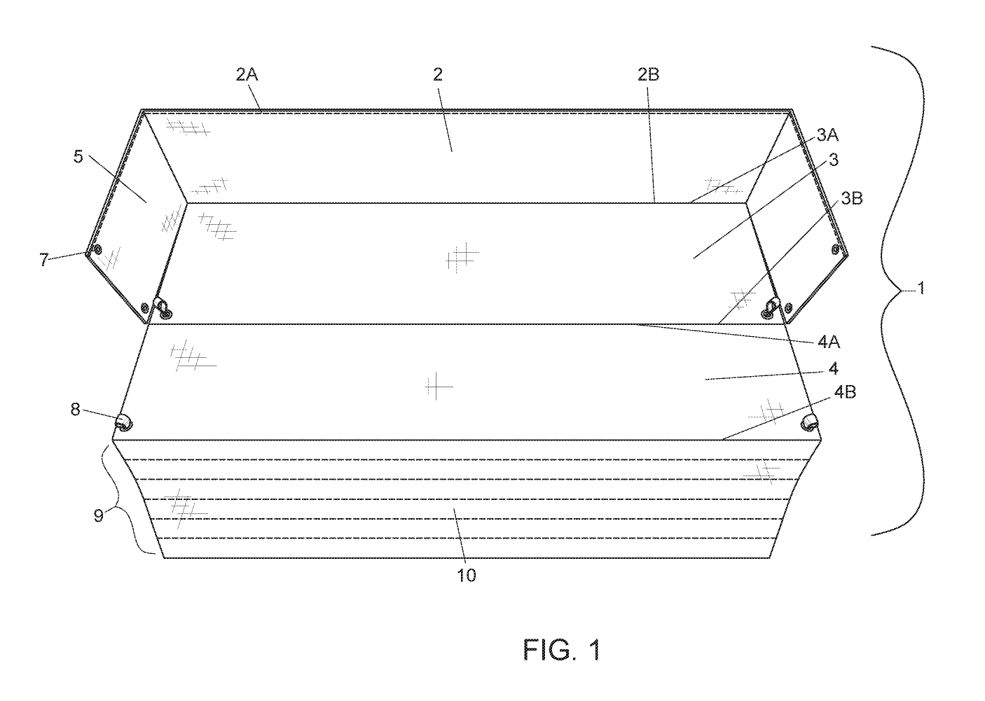

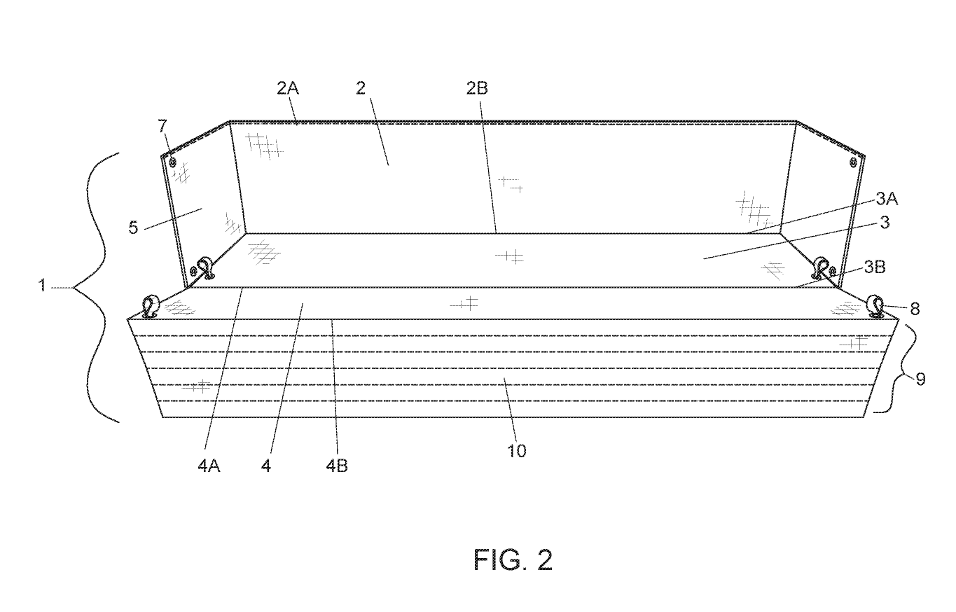

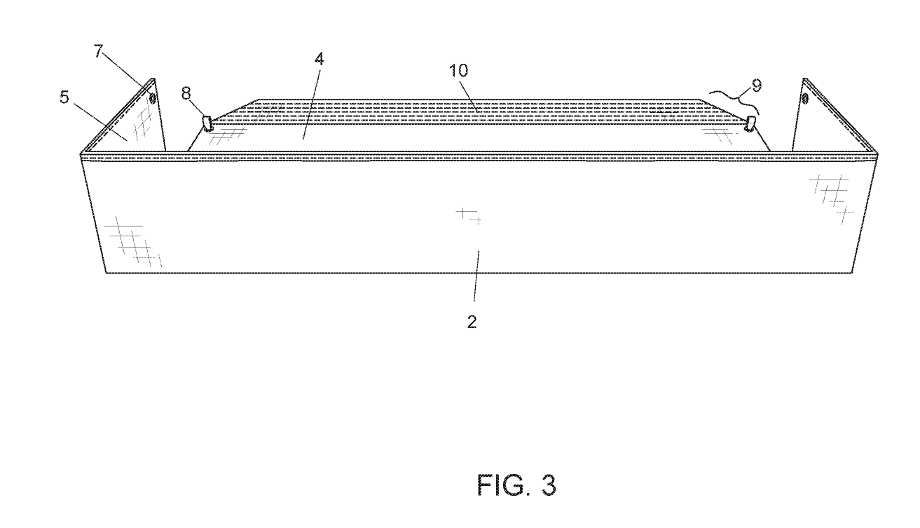

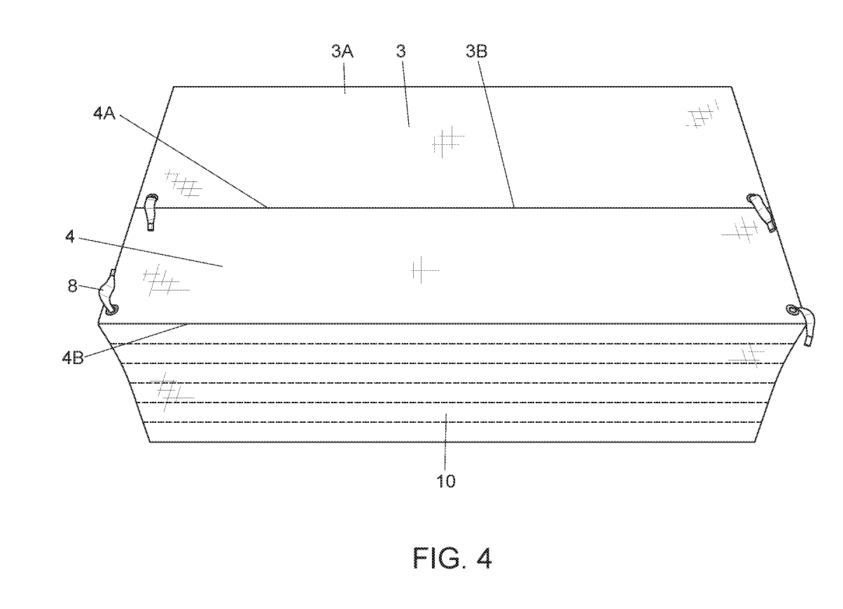

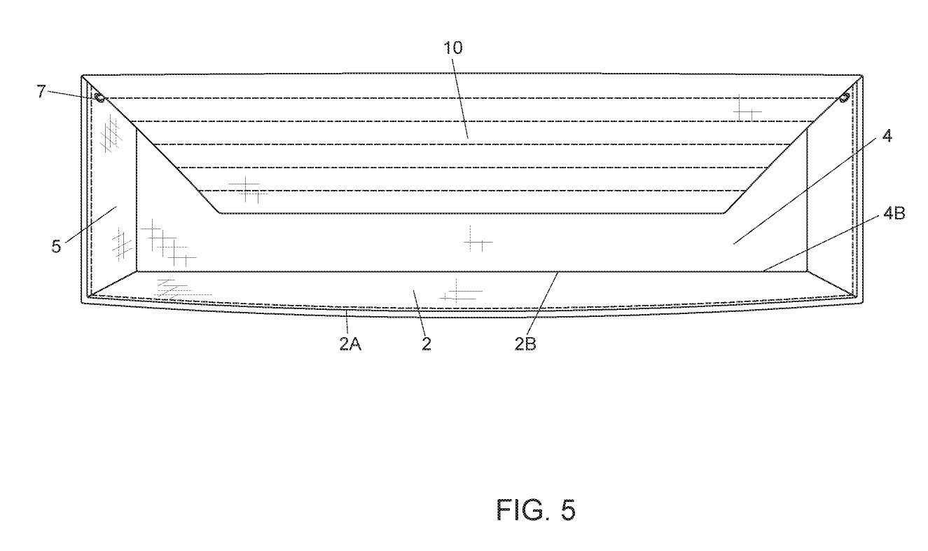

The preferred embodiment of the invention, as depicted in FIGS. 1 through 6, is a unitary devise that comprises top, back and side walls, and an immobilizing flap. The immobilizing flap is preferrably manufactured from the same material as the rest of the golf bag carrier and it depends from the carrier's body. The immobilizing flap is further reinforced with additional fabric to distribute the load across the entire length of the carrier's edge, thus minimizing stress concentration in any area. The golf bag of the present invention also comprises side and longitudinal joints that allow easy assembly in the desired shape and easy folding when not in use. The present invention further comprises engagement means and engagement receiving means situated in such an arrangement as to allow assembly into the shape of a cuboid open in the front. The preferred embodiment of the invention is a collapsible, foldable rectangular box comprising an open side when assembled which receives the golf bag(s).

The body (1) of the carrying and transporting system is constructed from a thick flexible fibrous material, fabric and thread. The top wall (2), back wall (3) and the bottom wall (4) delimit the long sides of a cuboid. The side walls (5) are the short sides of the cuboid. In the preferred embodiment of the invention, it is ideally made of somewhat flexible and sturdy foam board covered in fabric. The bottom wall (4) is made of a more rigid material that will not buckle under the weight of the carrier's contents, which is also covered in fabric.

The top wall (2) is attached to the back wall (3) which is in turn attached to the bottom wall (4) using flexible, longitudinal joints (6) that allow folding along the joints for easy and fast assembly and collapsing to a flatenned configuration for storage of the carrier.

The side walls (5) have multiple engagement receiving means (7) located along the side walls bottom end so that in the partially closed carrier position illustrated in FIG. 1, at least two receiving ends can receive two engagement means (8) protruding from the top end of the back wall (3). In the completely closed position, two engagement receiving means (7) receive two engagement means (8) as shown in FIG. 7.

The immobilizing flap (9), which is illustrated in FIGS. 1-5, is designed to be used in a pickup truck or a car or SUV with a hatchback door in the rear of the vehicle. The immobilizing flap (9) is permanently sewn into and depends from the bottom end (4b) of the bottom wall (4) of the carrier. In the preferred embodiment, the immobilizing flap (9) is constructed from an interface material that is sufficiently thin not to interfere with the closing of the tailgate or hatchback door of the vehicle. Multiple stabilizing strips (10) of a sturdy, durable material such as foam board are permanently affixed to the interface material longitudinally parallel to the walls (2), (3) and (4) of the carrier. The multiple thin horizontal strips naturally find their place in the contours of the vehicle tailgate or door jamb furthering resistance. The interface material and the stabilizing strips (10) are covered in fabric.

In order to install the carrying and transporting system of the present invention, the user positions the immobilizing flap (9) in such a way that the hatchback door or tailgate of the vehicle will close on the immobilizing flap (9) between the stabilizing strips (10). This arrangement prevents the flap and the carrier from sliding out of position during transport in the vehicle. The integration of the immobilizing flap (9) into the bottom end (4b) of the bottom wall (4) of the carrier results in the weight of the golf bag placed inside the carrier adding resistance to the immobiling flap, further preventing shifting of golf bag inside the carrier.

When the device is not in use, the side walls (5) and the immobilizing flap (9) can be tucked into the carrier walls (2), (3) and (4), which are themselves foldable along the joints, thus resulting in a thin, flat arrangement which makes the device easy to store.

What is claimed is:

1. A reusable, portable golf bag carrying and transporting container comprising:
a. a bottom and a top opposing walls, first and second opposing side walls and a back wall, and the bottom, top, side and back walls cooperating to define an open front box configuration 50606
b. for receiving and removing golf bags and other contents, each wall comprising a top, a bottom and a side edge, an exterior surface and an interior surface, the side walls further comprising engagement receiving means near the bottom and the bottom wall further comprising engagement means near the bottom so that the side walls can be engaged to the bottom wall;
c. two flexible and foldable side joints connecting the edges of the top wall to the top edges of the side wall;
d. two flexible and foldable longitudinal joints connecting the top wall with the back wall and the back wall with the bottom wall so the walls can lay flat or be folded to form an open front box configuration; and
e. an immobilizing flap attached to the bottom of the bottom wall, the immobilizing flap comprising an interface material, multiple strips of a sturdy, durable material affixed to the interface material the strips being placed in a parallel configuration with respect to the side of the carrying device from which the flap protrudes, and a material covering containing the interface material and strips.
